(19) United States
(12) Patent Application Publication
(10) Pub. No.: US 2026/0162623 A1
(43) Pub. Date: Jun. 11, 2026

(54) DISPLAY PANEL AND DISPLAY APPARATUS

(71) Applicant: LG Display Co., Ltd., Seoul (KR)

(72) Inventors: Kwang Hyun CHOI, Paju-si (KR); Soon Hwan HONG, Paju-si (KR); Chang Soo KIM, Paju-si (KR)

(73) Assignee: LG Display Co., Ltd., Seoul (KR)

(21) Appl. No.: 19/402,063

(22) Filed: Nov. 26, 2025

(30) Foreign Application Priority Data
Dec. 11, 2024 (KR) 10-2024-0183943

(51) Int. Cl. G09G 3/3266; G09G 3/3233

(52) U.S. Cl. CPC G09G 3/3266; G09G 3/3233; G09G 2300/0819; G09G 2300/0852; G09G 2300/0861; G09G 2310/0286; G09G 2310/0289; G09G 2310/08

(57) ABSTRACT

A display panel and the display apparatus each include an active area including a plurality of pixel areas and a plurality of scan circuit areas disposed between the plurality of pixel areas, a non-active area surrounding the active area and disposed between the active area and an edge of the display panel, an emission driver configured to provide an emission control signal, a plurality of pixel circuits disposed in the plurality of pixel areas and configured to control emission of lights by a plurality of light emitting devices based on the emission control signal, and a plurality of scan circuits disposed in the plurality of scan circuit areas and configured to receive the emission control signal and generate a scan signal which is to be supplied to the plurality of pixel circuits, wherein the plurality of scan circuits receive the emission control signal to generate the scan signal.

### CROSS-REFERENCE TO RELATED APPLICATIONS

This application claims priority to Korean Patent Application No. 10-2024-0183943, filed in the Republic of Korea on Dec. 11, 2024, the entire contents of which is hereby expressly incorporated by reference into the present application.

### BACKGROUND

### Field

The present disclosure relates to a display panel and a display apparatus.

### Discussion of the Related Art

As information-oriented society advances, the demands for display apparatuses for displaying an image are variously increasing. Recently, various flat display apparatuses, such as electroluminescent display apparatuses including organic light emitting diode (OLED) display apparatuses, quantum dot light emitting diode (QLED) display apparatuses, and micro light emitting diode (Micro-LED) display apparatuses are used. These electroluminescent display apparatuses have advantages, such as miniaturization, lightness, thinness, and low-power driving, and thus, are being widely used.

Recently, in electroluminescent display apparatuses, gate in panel (GIP) type devices are being developed where gate drivers for generating a scan signal supplied to gate electrodes of switching transistors included in pixels are directly formed at both sides of an active area. However, in the GIP type where gate drivers are disposed at both sides of an active area, when a display panel is provided so a horizontal length is several times longer than a vertical length like vehicles, there is a problem where operation stability and luminance uniformity are reduced due to resistive-capacitive (RC) delay. To solve such a problem, a gate driver in active area (GIA) type where gate drivers are distributed and disposed in an active area is being newly developed.

However, in the GIA type devices, because gate drivers are advantageously disposed in a very narrow space of an active area, a single gate driver can be disposed to service a plurality of regions of an active area, and a node connection line connected to one gate driver can overlap a plurality of pixel areas. As a result,, there is a problem where luminance is affected by coupling which occurs between the node connection line and a circuit of a pixel area.

### SUMMARY OF THE DISCLOSURE

To overcome the aforementioned problem of the related art, the present disclosure can provide a display panel and a display apparatus, in which a scan circuit applied to a GIA structure can be simplified.

To achieve these objects and other advantages and in accordance with the purpose of the disclosure, as embodied and broadly described herein, a display panel includes: an active area including a plurality of pixel areas and a plurality of scan circuit areas disposed between the plurality of pixel areas; a plurality of pixel circuits disposed in the plurality of pixel areas and configured to control emission of lights by a plurality of light emitting devices based on an emission control signal. In addition, a plurality of scan circuits are disposed in the plurality of scan circuit areas and are configured to generate a scan signal to be supplied to the plurality of pixel circuits, in which the plurality of scan circuits receive the emission control signal to generate the scan signal.

Also, a first division scan circuit disposed in a first scan circuit area of the plurality of scan circuit areas and electrically connected to a first gate line can generate a first scan signal to output the first scan signal to the first gate line based on a first emission control signal, and first pixel circuits respectively disposed in the plurality of pixel areas and electrically connected to the first gate line can receive the first emission control signal and the first scan signal of the first division scan circuit to control emission of light by a light emitting device included in each of the first pixel circuits. Further, the timings of a gate on voltage and a gate off voltage of the first emission control signal input to the first division scan circuit can be synchronized with timings of a gate on voltage and a gate off voltage of the first emission control signal input to the first pixel circuits.

In addition, a second division scan circuit disposed in a second scan circuit area spaced apart from the first scan circuit area among the plurality of scan circuit areas and electrically connected to the first gate line can generate the first scan signal to output the first scan signal to the first gate line based on the first emission control signal, and the first pixel circuits can receive the first emission control signal and the first scan signal of the second division scan circuit to control emission of light by the light emitting device included in each of the first pixel circuits. Further, the timings of a gate on voltage and a gate off voltage of the first emission control signal input to the second division scan circuit can be synchronized with timings of a gate on voltage and a gate off voltage of the first emission control signal input to the first pixel circuits. Also, timings of a gate on voltage and a gate off voltage of the first scan signal output from the first division scan circuit can be synchronized with timings of a gate on voltage and a gate off voltage of the first scan signal output from the second division scan circuit.

In addition, a second scan circuit electrically connected to a second gate line differing from the first gate line can receive a second emission control signal having a phase differing from a phase of the first emission control signal to generate a second scan signal having a phase differing from a phase of the first scan signal and output the second scan signal to the second gate line. Also, second pixel circuits electrically connected to the second gate line can receive the second scan signal and the second emission control signal to control emission of light by a light emitting device included in each of the second pixel circuits. Further, the timings of a gate on voltage and a gate off voltage of the second emission control signal input to the second scan circuit can be synchronized with timings of a gate on voltage and a gate off voltage of the second emission control signal input to each of the second pixel circuits. Further, the first scan signal output from the first division scan circuit or the second division scan circuit can be input to the second scan circuit and the second pixel circuits.

In various examples, each of the plurality of scan circuits can include: a capacitor connected to a first node at one end thereof and connected to an output terminal at the other end thereof; a first transistor connected to the first node at one end thereof and configured to receive a previous scan signal through the other end thereof to charge a voltage of the previous scan signal in the first node; a second transistor supplied with an initialization voltage through one end thereof, connected to the first node at the other end thereof, and configured to supply the initialization voltage to the first node, based on the emission control signal. Thes example scan circuits can further include a third transistor supplied with the initialization voltage through one end thereof, connected to the first node at the other end thereof, and configured to supply the initialization voltage to the other end of the capacitor based on the emission control signal; and a fourth transistor supplied with a clock signal through one end thereof, connected to the output terminal at the other end thereof, and configured to bootstrap a voltage of the clock signal to output a current scan signal to the output terminal, based on a voltage of the first node.

Also, in an initialization period, the second and third transistors can be turned on based on a gate on voltage of the emission control signal and can initialize the first node into the initialization voltage. Further, in a charge period, the first transistor can be turned on based on a gate on voltage of the previous scan signal, can charge the first node with a voltage of the previous scan signal, and can turn on the fourth transistor. Still further, in an output period, the fourth transistor can receive the clock signal and can output the current scan signal generated through bootstrapping based on a voltage of the previous scan signal stored in the first node.

In addition, the display panel can further include a fifth transistor connected between the first transistor and the second transistor at one end thereof and connected to the first node at the other end thereof. The display panel can further include a non-active area disposed outside the active area, in which an emission (EM) driver supplying the emission control signal to the pixel circuit and the scan circuit can be disposed in the non-active area.

Also, in other examples, a display apparatus includes: an active area including a plurality of pixel areas and a plurality of scan circuit areas disposed between the plurality of pixel areas; a plurality of pixel circuits disposed in the plurality of pixel areas and configured to control emission of lights by a plurality of light emitting devices based on an emission control signal; and a plurality of scan circuits disposed in the plurality of scan circuit areas and configured to generate a scan signal which is to be supplied to the plurality of pixel circuits, in which the plurality of scan circuits receive the emission control signal to generate the scan signal. Also, a first division scan circuit disposed in a first scan circuit area of the plurality of scan circuit areas and electrically connected to a first gate line can generate a first scan signal to output the first scan signal to the first gate line based on a first emission control signal, and first pixel circuits respectively disposed in the plurality of pixel areas and electrically connected to the first gate line can receive the first emission control signal and the first scan signal of the first division scan circuit to control emission of light by a light emitting device included in each of the first pixel circuits. Similarly, a second division scan circuit disposed in a second scan circuit area spaced apart from the first scan circuit area among the plurality of scan circuit areas and electrically connected to the first gate line can generate the first scan signal to output the first scan signal to the first gate line based on the first emission control signal, and the first pixel circuits can receive the first emission control signal and the first scan signal of the second division scan circuit to control emission of light by the light emitting device included in each of the first pixel circuits.

In addition, a second scan circuit can be electrically connected to a second gate line differing from the first gate line. This second scan circuit can receive a second emission control signal having a phase differing from a phase of the first emission control signal to generate a second scan signal having a phase differing from a phase of the first scan signal and output the second scan signal to the second gate line. Also, second pixel circuits electrically connected to the second gate line can receive the second scan signal and the second emission control signal to control emission of light by a light emitting device included in each of the second pixel circuits.

Further, the example display apparatus can further include a non-active area disposed outside the active area, in which an EM driver supplying the emission control signal to the pixel circuit and the scan circuit can be disposed in the non-active area. In an embodiment, a scan circuit can receive an emission control signal supplied to a pixel circuit and can use the emission control signal as a control signal for generating a scan signal, and thus, can be simplified. In an embodiment, as the scan circuit is simplified, coupling between the scan circuit and a pixel circuit can be minimized, and a defect occurrence rate caused by coupling can be reduced.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating a display apparatus according to an embodiment of the present disclosure;

FIG. 2 is a diagram illustrating an arrangement structure between a scan circuit disposed in a scan circuit area, a pixel circuit disposed in a pixel area, a gate line, and an emission signal line each illustrated in FIG. 1;

FIG. 3 is a diagram illustrating a connection relationship between a pixel circuit and first and second division scan circuits connected to a gate line of the same sequence number in FIG. 2;

FIG. 4 is a diagram illustrating a connection relationship between first and third scan circuits connected to gate lines of different sequence numbers in FIG. 2;

FIG. 5 is a diagram illustrating a first embodiment of a scan circuit according to the present disclosure;

FIG. 6 is a diagram illustrating an example of a scan timing diagram for operating the scan circuit illustrated in FIG. 5;

FIG. 7(a) to 12(b) are diagrams illustrating in detail an operating method of the first embodiment of the scan circuit illustrated in FIG. 5 based on the timing diagram illustrated in FIG. 6;

FIG. 13 is a diagram illustrating a second embodiment of a scan circuit according to the present disclosure;

FIG. 14 is a diagram illustrating an example of a pixel circuit according to the present disclosure;

FIG. 15 is a diagram illustrating an example of a pixel timing diagram for operating the pixel circuit illustrated in FIG. 14;

FIG. 16(a) and 16(b) illustrate a diagram illustrating a comparison of the timing diagram of FIG. 6 and the pixel timing diagram of FIG. 15;

FIG. 17 is a diagram illustrating an example where an EM driver of FIG. 1 is disposed in a non-active area;

FIG. 18 is a diagram illustrating an example where an EM driver is disposed in an active area; and

FIGS. 19 and 20 are diagrams illustrating the number of scan circuits connected to one gate line.

### DETAILED DESCRIPTION OF THE EMBODIMENTS

Hereinafter, exemplary embodiments will be described in detail with reference to the accompanying drawings. In the specification, in adding reference numerals for elements in each drawing, it should be noted that like reference numerals already used to denote like elements in other drawings are used for elements wherever possible. In the following description, when the detailed description of the relevant known function or configuration is determined to unnecessarily obscure an important point of the present disclosure, the detailed description will be omitted.

Like reference numerals refer to like elements. Also, a thickness, a ratio, and a dimension of each element described herein are illustrated to be partially enlarged or reduced for convenience of effective description. A scale of each element illustrated in the drawings of the present disclosure may have a scale which differs from a real scale, for convenience of description, but is not limited to a scale illustrated in the drawings.

In the present disclosure, when an arbitrary element (or a region, a layer, a portion, etc.) is described as “being on” “connected,” or “coupled,” this may denote that the arbitrary element may be directly connected/coupled to another element, or a third element may be disposed therebetween. Also, the term “and/or” may include all of one or more combinations capable of being defined by relevant elements.

In addition, terms like a first and a second may be used to describe various elements, but the elements should not be limited by the terms. The terms may be used only as object for distinguishing an element from another element. For example, without departing from the spirit and scope of the inventive concept, a first element may be referred to as a second element, and similarly, the second element may be referred to as the first element. The terms of a singular form may include plural forms unless referred to the contrary.

Also, the terms “under,” “below,” “on,” and “above,” may be used to describe a correlation between elements illustrated in the drawings. The terms may be a relative concept and may be described with respect to a direction illustrated in the drawings. For example, unless “just” or “direct” is used, one or more other elements between two elements may be disposed. Spatially relative terms, such as “below,” “beneath,” “lower,” “above,” and “upper” may be used herein for easily describing a relationship between one device or elements and other devices or elements as illustrated in the drawings. Therefore, for example, “under” and “lower” may be opposite to “on” and “upper” with respect to a first element.

Further, it should be understood that spatially relative terms are terms including different orientations of elements in use or operation, in addition to the orientation illustrated in the drawings. For example, if a device in the drawings is turned over, elements described as being on the “below” or “beneath” sides of other elements may be placed on “above” sides of the other elements. Therefore, the exemplary term “lower” may include both orientations of “lower” and “upper.” Likewise, the exemplary term “above” or “upper” may include both orientations of above and below. Also, it should be understood that the meaning of “include,” “comprise,” “including,” or “comprising,” specifies a property, a region, a fixed number, a step, a process, an element and/or a component, but does not exclude other properties, regions, fixed numbers, steps, processes, elements and/or components.

Features of various embodiments of the present disclosure may be partially or overall coupled to or combined with each other and may be variously inter-operated with each other and driven technically as those skilled in the art can sufficiently understand. The embodiments of the present disclosure may be carried out independently from each other, or may be carried out together in co-dependent relationship. Also, the term “can” used herein includes all meanings and definitions of the term “may.”

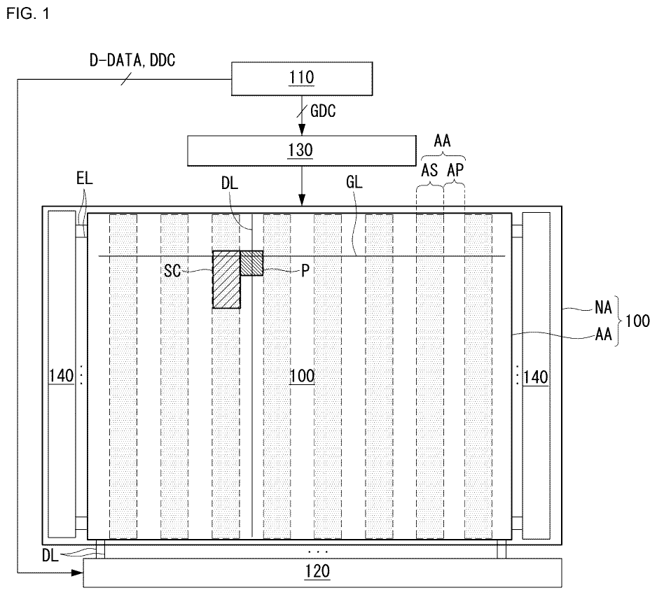

FIG. 1 is a block diagram illustrating an example of a display apparatus. As illustrated in FIG. 1, the display apparatus can include a display panel 100, a timing controller 110, a source driver 120, a gate driver (which includes a level shifter 130, an emission (EM) driver 140, and a scan circuit SC), and a pixel circuit P. Moreover, the display apparatus can further include a power circuit which supplies a voltage for driving the source driver 120, the gate driver 130, 140, and SC, and the pixel circuit P. Further, the display panel 100 can include an active area AA and a non-active area NA. The non-active area NA can be disposed along an edge of the display panel 100, and the non-active area NA can be disposed outside the active area AA in the display panel 100. The active area AA can display an image based on an image signal, and the non-active area NA can include a bezel region, which does not display an image, of the display panel 100.

In addition, the EM driver 140 can be disposed in the non-active area NA, and the EM driver 140 can generate an emission control signal to supply the emission control signal to the pixel circuit P and a scan circuit SC through an emission control line. However, this can be an embodiment, and a plurality of EM drivers 140 can be distributed and disposed in the active area AA along with the scan circuit SC. Hereinafter, for convenience of description, an example where the EM driver 140 is disposed in the non-active area NA will be described.

Further, the active area AA can include a plurality of pixel areas AP and a plurality of scan circuit areas AS. The plurality of pixel areas AP and the plurality of scan circuit areas AS can be alternately arranged in a first direction (or a horizontal direction), and the plurality of scan circuit areas AS can be arranged between the plurality of pixel areas AP. Alternatively, as shown in FIG. 1, each of the plurality of pixel areas AP and the plurality of scan circuit areas AS can extend in a second direction (or a vertical direction) intersecting the first direction.

In addition, pixels P (or pixel circuits P) can be disposed in the plurality of pixel areas AP, and a plurality of scan circuits SC can be distributed and disposed in the plurality of scan circuit areas AS. In FIG. 1, for convenience of understanding, only one scan circuit SC and one pixel P are illustrated, but a plurality of pixel circuits P can be disposed in the plurality of pixel areas AP, and the plurality of scan circuits SC can be disposed in the plurality of scan circuit areas AS.

Also, in the active area AA, a plurality of data lines DL extending in a column direction (or a vertical direction) can intersect a plurality of gate lines GL extending in a row direction (or a horizontal direction), and pixel circuits P can be arranged as a matrix type in intersection areas therebetween to configure a pixel array. In FIG. 1, for convenience of understanding, an example where one data line DL and one gate line GL intersect each other in one pixel circuit P disposed in the pixel area AP is illustrated. In addition, each of the plurality of data lines DL can be connected to pixel circuits P adjacent to each other in the column direction in common, each of the plurality of gate lines GL can be connected to pixel circuits P adjacent to each other in the row direction in common, the data lines DL can be electrically separated from one another, and the gate lines GL can be electrically separated from one another. For example, each data line DL can be disposed to extend in the first direction in each of the plurality of pixel areas AP, and each gate line GL can be disposed to overlap the plurality of pixel areas AP and the plurality of scan circuit areas AS and extend in the second direction. Moreover, a plurality of emission control lines connected to the EM driver 140 can be disposed to overlap the plurality of pixel areas AP and the plurality of scan circuit areas AS and extend in the second direction. In FIG. 1, a structure where one data line DL intersects one gate line GL is illustrated for example.

In addition, a plurality of pixels P can be grouped into a plurality of pixel groups and can display various colors. In an situation where a pixel group for color expression is defined as a unit pixel, one unit pixel can be configured to include red (R), green (G), and blue (B) subpixels, or can be configured to include red (R), green (G), blue (B), and white (W) subpixels. Further, each of the pixels P can include a light emitting device and a driving element which generates an emission current with a gate-source voltage to drive the light emitting device. Still further, the light emitting device can include an anode electrode, a cathode electrode, and an organic compound layer formed between the electrodes. Also, the organic compound layer can include a hole injection layer (HIL), a hole transport layer (HTL), an emission layer (EML), an electron transport layer (ETL), and an electron injection layer (EIL), but is not limited thereto. When a pixel current flows in the light emitting device, a hole passing through the hole transport layer (HTL) and an electron passing through the electron transport layer (ETL) can move to the emission layer (EML) to generate an exciton, and thus, the emission layer (EML) can emit visible light. Also, the organic compound layer can be replaced with an inorganic compound layer.

In addition, the driving element can be implemented with a low temperature polysilicon (LTPS) or oxide thin film transistor based on an organic substrate (or a plastic substrate), but is not limited thereto. Also, the driving element can be implemented with a complementary metal oxide semiconductor (CMOS) transistor based on a silicon wafer (Si-wafer). In addition, in the driving element, an electrical characteristic (for example, a threshold voltage and electron mobility) thereof should be uniform in all pixels, but there can be a difference between the pixels P due to a process deviation and a device characteristic deviation. The electrical characteristic of the driving element can vary as a display driving time elapses, and moreover, there can be a difference between the pixels P in degree of degradation.

To compensate for the electrical characteristic deviation of the driving element, an internal compensation method can be applied to an electroluminescent display apparatus. In various examples, the internal compensation method can compensate for an electrical characteristic variation of the driving element by using an internal compensator included in the pixel circuit P so the electrical characteristic variation of the driving element does not affect an emission current. Accordingly, the internal compensator can include one or more capacitors and a plurality of switching elements implemented with a thin film transistor (or a CMOS transistor).

In some embodiments, certain elements, such as a switching element where a source or a drain thereof is connected to a gate of the driving element) included in the pixel circuit P by using an oxide transistor are used. Such an oxide transistor can use oxide instead of polysilicon, and for example, can use IGZO where indium (In), gallium (Ga), zinc (Zn), and oxygen (O) are bonded to one another. In addition, the oxide transistor can be 10 or more times higher in electron mobility than an amorphous silicon transistor and can be far lower in manufacturing cost than the LTPS transistor. Also, because the oxide transistor is low in off current, the driving stability and reliability of the oxide transistor can be high in low-speed driving where an off period of a transistor is relatively long. Accordingly, the oxide transistor can be applied to an OLED television (TV) which can need a high resolution and low-power driving or may not respond to a screen size through an LTPS process.

As described above, the pixel circuit P can initialize the driving transistor and a capacitor connected to the driving transistor in an initialization period and can store a data voltage, supplied from the source driver 120, in a gate node of the driving transistor in synchronization with the scan signal from the scan circuit SC in a programming period, and in an emission period, the light emitting device can be supplied with the driving current generated based on a data voltage by the driving transistor and can thus be driven based on an emission control signal. The source driver 120, the gate driver 130, 140, and SC, and a power circuit can configure a panel driving circuit for driving the pixel circuit P included in the display panel 100, and the panel driving circuit can be connected to the pixel array of the display panel 100 through a plurality of signal lines.

In addition, the timing controller 110 can supply digital video data D-DATA, transferred from a host system to the source driver 120, and the timing controller 110 can receive a timing signal such as a vertical synchronization signal, a horizontal synchronization signal, a data enable signal, and a dot clock from the host system to generate timing control signals for controlling an operation timing of the panel driving circuit. Also, the timing control signals can include a gate timing control signal GDC for controlling an operation timing of the gate driver 130, 140, and SC, a data timing control signal DDC for controlling an operation timing of the source driver 120, and a power timing control signal for controlling an operation timing of the power circuit. Further, the timing controller 110 can temporally divide one frame period into an initialization period, a programming period succeeding the initialization period, and an emission period succeeding the programming period to supply the timing control signals. Still further, the timing controller 110 can control an operation of the panel driving circuit so all pixels P are initialized in the initialization period, control an operation of the panel driving circuit so the pixels P are programmed based on a row line progressive scheme in the programming period, and control an operation of the panel driving circuit so all pixels P emit lights in the emission period.

In addition, the host system can be an application processor (AP) applied to mobile devices, wearable devices, and virtual/augmented reality (VR/AR) devices. Also, the host system can be a main board of television systems, set-top box, navigation systems, personal computers, and home theater systems, but is not limited thereto.

In operation, the source driver 120, which is connected to the pixels P through the data lines DL, can generate analog voltages needed for driving of the pixels P with each of the analog voltages including a data voltage and a reference voltage. The source driver 120 can then respectively supply the analog voltages to the data lines DL. Also, the source driver 120 can sample and latch the digital image data D-DATA input from the timing controller 110 to generate parallel data based on the data timing control signal DDC, and a digital-to-analog converter (DAC) can convert the digital image data D-DATA into analog data voltages based on gamma compensation voltages. Then, the source driver 120 can respectively supply the data voltages to the pixels P through the data lines DL. In various examples, the data voltages can be analog voltage values of different voltage levels to correspond to image gray levels which are to be expressed in the pixels P. Further, the source driver 120 can generate the reference voltage of a predetermined fixed voltage level to supply the reference voltage to the pixels P through the data lines DL based on the data control signal DDC.

In addition, the source driver 120 can output data voltages in the programming period based on the data timing control signal DDC, and can output the reference voltage in the initialization period and the emission period. In various examples, the source driver 120 can include a plurality of source driver 120 integrated circuits (ICs), and each of the source driver 120 ICs can include a shift register, a latch, a level shifter, the DAC, and an output buffer.

Further, as stated above, the gate driver 130, 140, and SC can include a level shifter 130, the EM driver 140, and the scan circuit SC and can generate a control signal for controlling a gate electrode of a transistor included in the pixel circuit P. Also, the pixel circuit P, the EM driver 140, and the scan circuit SC can be disposed in the display panel 100.

In addition, the level shifter 14 can be supplied with the gate timing control signal GDC from the timing controller 110 to convert a voltage of the gate timing control signal GDC into a gate on voltage and a gate off voltage, and a level-converted gate timing control signal GDC can be input a clock signal of the EM driver 140 and the scan circuit SC. Also, the EM driver 140 can receive a voltage of the gate timing control signal GDS from the level shifter 130 to generate the emission control signal and can input the generated emission control signal as a control signal for the pixel circuit P and the scan circuit SC. In FIG. 1, an example where the EM driver 140 is provided in the non-active area NA of the display panel 100 is illustrated, but the present disclosure is not limited thereto and the EM driver 140 can be included in the scan circuit area AS of the active area AA. Hereinafter, an example where the EM driver 140 is disposed in the non-active area NA of the display panel 100 will be described.

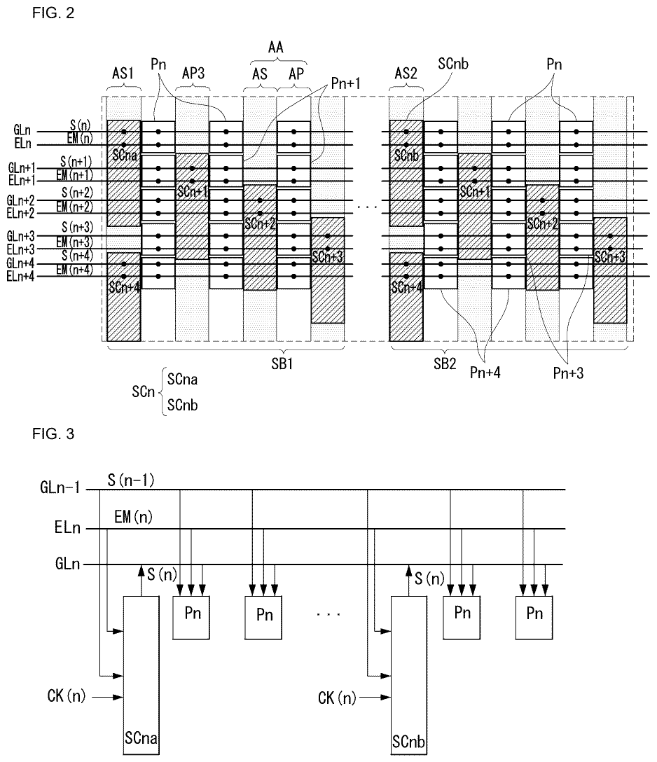

Next, the scan circuit SC can receive the emission control signal of the EM driver 140 and a clock signal of the level shifter 130 to generate the scan signal and can provide the scan signal to the pixel circuit P. Next, the scan circuit SC can sequentially supply the scan signal to the gate lines GL in synchronization with a data voltage based on control by the timing controller 110. Also, a plurality of scan circuits SC can be distributed and disposed as a gate driver in active area (GIA) type in a plurality of scan circuit areas AS included in the active area AA, and to minimize RC delay, the plurality of scan circuits SC can multi-contact the same scan line. Further, the scan circuit SC can be connected to the pixels P through the gate lines GL and can be connected to the pixels P through the emission control lines (for example, ELn to ELn+4 of FIG. 2).

In addition, each of the scan signals generated by the scan circuit SC can be generated as a pulse type which swings between a gate on voltage and a gate off voltage. In operation, the gate on voltage can be set to a voltage which is greater than a threshold voltage of a transistor, and the gate off voltage can be set to a voltage which is less than the threshold voltage of the transistor. Also, the transistor included in the scan circuit SC can be turned on in response to the gate on voltage, or can be turned off in response to the gate off voltage. Further, when the transistor included in the scan circuit SC is a p-type thin film transistor (TFT), the gate on voltage can be a gate low voltage VGL, and the gate off voltage can be a gate high voltage VGH, and when the transistor included in the scan circuit SC is an n-type TFT, the gate on voltage can be the gate high voltage VGH, and the gate off voltage can be the gate low voltage VGL. Hereinafter, an example where the transistor included in the scan circuit SC is a p-type TFT will be described.

Starting with power generation, the power circuit can process an input power to generate a fixed high-level power VDD and a fixed low-level power VSS or generate the gate high voltage VGH and the gate low voltage VGL for the scan circuit SC based on a power timing control signal PDC. The power circuit can supply the pixels P with the high-level power VDD and the low-level power VSS as a driving power for driving the pixels P, or the power circuit can supply the scan circuits SC with the gate high voltage VGH and the gate low voltage VGL as a voltage for operating the scan circuit SC. In an embodiment, a plurality of scan circuits SC can receive an emission control signal to generate a scan signal and can supply the scan signal to a plurality of pixel circuits P, and the plurality of pixel circuits P can receive the scan signal and the emission control signal to control a light emitting device, and thus, the scan circuit SC and the pixel circuit P can be connected to the same gate line GL and the same emission signal line in common. This will be described below in detail.

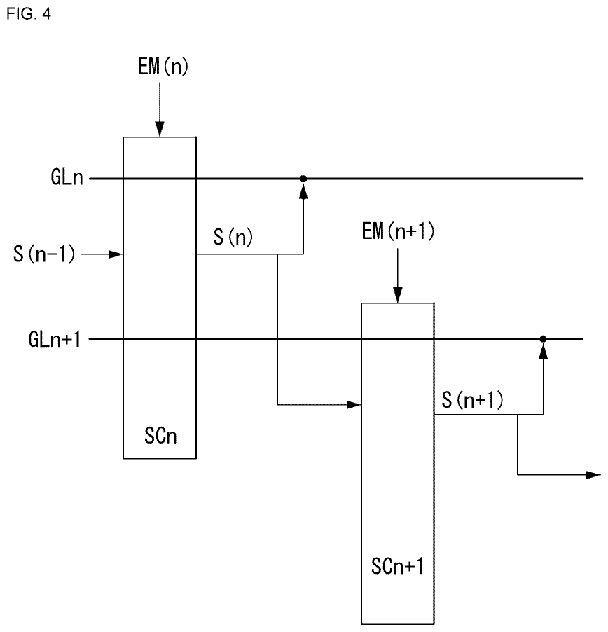

FIG. 2 is a diagram illustrating an arrangement structure between a scan circuit disposed in a scan circuit area, a pixel circuit disposed in a pixel area, a gate line, and an emission signal line each illustrated in FIG. 1, FIG. 3 is a diagram illustrating a connection relationship between a pixel circuit and first and second division scan circuits connected to a gate line of the same sequence number in FIG. 2, and FIG. 4 is a diagram illustrating a connection relationship between first and third scan circuits connected to gate lines of different sequence numbers in FIG. 2. In FIG. 2, for convenience of understanding, the illustrations of a data line DL through which a data voltage is supplied with an assumption a driving voltage line can be connected to a plurality of pixel circuits Pn to Pn+4, and a clock line can be connected to a plurality of scan circuits SC. Further, a plurality of data lines DL can be disposed in a plurality of pixel areas AP, and the driving voltage line and the clock line can be disposed in a plurality of scan circuit areas AS. Hereinafter, an example where the data line DL, the driving voltage line, and the clock line are provided will be described.

FIGS. 3 and 4 illustrate circuitry in scan circuit areas AS, such as the scan circuit areas AS of FIG. 2, where a gate line GL and at least one control signal line are disposed to overlap the scan circuit area AS and the pixel area AP, the scan circuit SC is disposed in the scan circuit area AS, and the pixel circuit P is disposed in the pixel area AP. Moreover, in FIG. 3, an example is illustrated where first and second division scan circuits SCna and SCnb and a plurality of first pixel circuits Pn are connected to a previous gate line GLn−1 which is higher in priority than a first gate line GLn and supplies a previous scan signal S(n−1), but can be omitted based on a structure of a scan circuit and a structure of a pixel circuit. Hereinafter, for convenience of description, an example relating to FIG. 3 will be described.

As illustrated in FIG. 2, a plurality of emission signal lines ELn to ELn+4 can be disposed to extend in a first (left-to-right) direction across the plurality of pixel areas AP and the plurality of scan circuit areas AS. Also, a plurality of emission control signals EM(n) to EM(n+4) supplied from the EM driver 140 can be sequentially supplied to the plurality of emission signal lines ELn to ELn+4. In addition, a plurality of gate lines GLn to GLn+4 can be disposed to extend in the first direction across the plurality of pixel areas AP and the plurality of scan circuit areas AS included in the active area AA, and a plurality of scan signals S(n) to S(n+4) can be sequentially supplied from the plurality of scan circuits SC to the plurality of gate lines GLn to GLn+4.

Also, as in FIG. 2, a plurality of pixel circuits Pn to Pn+4 can be disposed in the plurality of pixel areas AP. In addition, the plurality of gate lines GLn to GLn+4 and the plurality of emission signal lines ELn to ELn+4 can be disposed to respectively overlap the plurality of pixel circuits Pn to Pn+4 and can be electrically connected to the plurality of pixel circuits Pn to Pn+4. For example, a first gate line GLn and a first emission signal line ELn can be disposed to overlap first pixel circuits Pn disposed in a first row line and can be electrically connected to the first pixel circuits Pn, and a second gate line GLn+1 and a second emission signal line ELn+1 can be disposed to overlap second pixel circuits Pn+1 disposed in a second row line and can be electrically connected to the second pixel circuits Pn+1.

Next, pixel circuits disposed in each row line can receive a scan signal from each gate line and an emission control signal from each emission signal line and can control the emission of light by a light emitting device included in each of pixel circuits based on a data voltage which is input thereto in synchronization with the scan signal. For example, the first pixel circuits Pn can receive a first scan signal S(n) from the first gate line GLn and can receive a first emission control signal EM(n) from a first emission signal line ELn to control the emission of light by a light emitting device of each first pixel circuit Pn, and moreover, the second pixel circuits Pn+1 can receive a second scan signal S(n+1) from the second gate line GLn+1 and can receive a second emission control signal EM(n+1) from a second emission signal line ELn+1 to control the emission of light by a light emitting device of each second pixel circuit Pn+1. According to the example of FIG. 2, each of the plurality of pixel circuits Pn to Pn+4 can be, for example, a unit pixel including R, G, and B subpixels. For example, each of the plurality of pixel circuits Pn to Pn+4 can include a subpixel emitting red (R) light, a subpixel emitting green (G) light, and a subpixel emitting blue (B) light. In other examples, a plurality of pixels disposed in an arbitrary row line can be electrically connected to gate lines of another row based on a structure of a pixel circuit. This will be described below with reference to FIG. 3.

As is further illustrated in FIG. 2, a plurality of scan circuits SC to SCn+4 can be respectively distributed and disposed in the plurality of scan circuit areas AS. In operation, the plurality of scan circuits SCn to SCn+4 can respectively receive a plurality of emission control signals EM(n) to EM(n+4) from the plurality of emission signal lines ELn to ELn+4 and can respectively generate a plurality of scan signals S(n) to S(n+4) to sequentially output the plurality of scan signals S(n) to S(n+4) to the plurality of gate lines GLn to GLn+4.

Also, the plurality of gate lines GLn to GLn+4 and the plurality of emission signal lines ELn to ELn+4 can be disposed to respectively overlap the plurality of scan circuits SCn to SCn+4 and can be electrically connected to the plurality of scan circuits SCn to SCn+4. In operation, each of the plurality of scan circuits SCn to SCn+4 according to the present disclosure can receive the emission control signal to generate the scan signal, and thus a structure of the scan circuit can be simplified, thereby allowing one scan circuit SC to be configured in one scan circuit area AS. For instance, each of the plurality of scan circuits SCn to SCn+4 may receive the emission control signal and, responsive to receiving the emission control signal, generate the scan signal. For example, the first division scan circuit SCna can be included in a first scan circuit area AS1, and the second division scan circuit SCnb can be included in a second scan circuit area AS2. Accordingly, an operation error of the display panel 100 caused by coupling between a scan circuit and a pixel circuit can be minimized. Here, all of the first division scan circuit SCna and the second division scan circuit SCnb can be included in a plurality of first scan circuits SCn which supply the first scan signal SC(n) to the first gate line GLn. Compared with an example where one scan circuit SC is configured to service the plurality of scan circuit areas AS, the present disclosure can enhance the operation stability of the display panel 100.

In addition, to prevent RC delay based on a length of the gate line GL, the devices of the present disclosure can supply the same scan signal to a plurality of pixels arranged in the first direction by block units. For example, the plurality of first scan circuits SCn including the first division scan circuit SCna and the second division scan circuit SCnb can both contact one first gate line GLn.

However, as a length of the gate line GL increases, the voltage drop of the scan signal caused by RC delay can occur, and due to this, an operation error of the pixel circuit P can occur. To address this issue, a plurality of scan circuits can each contact the gate line GL so the same scan signal is supplied to the same gate line GL by block units. For example, first to fourth scan circuits SCn to SCn+3 which are respectively connected to first to fourth gate lines GLn to GLn+3 and sequentially supply first to fourth scan signals S(n) to S(n+3) can be included in a first scan block SB1, and the first to fourth scan circuits SCn to SCn+3 which are respectively connected to the first to fourth gate lines GLn to GLn+3 and sequentially supply the first to fourth scan signals S(n) to S(n+3) can be included in a second scan block SB2 spaced apart from the first scan block SB1 in the first direction based on the same arrangement as the first scan block SB1. Here, each of the first division scan circuit SCna of the first scan block SB1 and the second division scan circuit SCnb of the second scan block SB2 can be connected to the first gate line GLn.

Further, the scan signals supplied from the first scan block SB1 and the second scan block SB2 to the same gate line can be synchronized with each other. In other words, the first division scan circuit SCna disposed in a first scan circuit area AS1 of the first scan block SB1 and the second division scan circuit SCnb disposed in a second scan circuit area AS2 of the second scan block SB2 can output a gate on voltage and a gate off voltage of the first scan signal SC(n) to the first gate line GLn at the same time. In this manner, each of a second scan circuit SCn+1 disposed in a third scan circuit area AS3 of the first scan block SB1 and a second scan circuit SCn+1 disposed in a corresponding scan circuit area AS of the second scan block SB2 can be connected to the second gate line GLn+1 and can output a gate on voltage and a gate off voltage of the second scan signal SC(n+1) to the second gate line GLn+1 at the same time. Moreover, as in FIG. 2, in each of the first and second blocks SB1 and SB2, a fifth scan circuit SCn+4 which supplies a fifth scan signal S(n+4) to a fifth gate line GLn+4 can be provided under each of the first and second division scan circuits SCna and SCnb. In FIG. 2, an example where one block supplies a scan signal to four gate lines has been described, but the present disclosure is not limited thereto and one block can supply a scan signal to a plurality of gate lines.

Next, as illustrated in FIG. 3, each of the first and second division scan circuits SCna and SCnb can receive a clock signal CK(n), the first emission control signal EM(n) from the first emission signal line ELn, and a previous scan signal S(n−1) from a previous gate line GLn−1 to generate the first scan signal S(n) and can output the first scan signal S(n) to the first gate line GLn. As is also shown, a plurality of first pixel circuits Pn connected to the first gate line GLn can receive the first emission control signal EM(n), the previous scan signal S(n−1), and the first scan signal S(n) output from the first and second division scan circuits SCna and SCnb to control the emission of light by a light emitting device included in each thereof. FIG. 3 illustrates an example where a plurality of first pixel circuits Pn receive the previous scan signal S(n−1) from the previous gate line GLn−1. However, the first pixel circuits Pn the previous scan signal S(n−1) can be omitted based on a structure of the first pixel circuits Pn. Hereinafter, for convenience of description, a structure illustrated in FIG. 3 will be described. Here, timings of a gate on voltage and a gate off voltage of the first emission control signal EM(n) input to the first division scan circuit SCna can be synchronized with timings of a gate on voltage and a gate off voltage of the first emission control signal EM(n) input to the second division scan circuit SCnb. Moreover, timings of the gate on voltage and the gate off voltage of the first emission control signal EM(n) input to each of the first and second division scan circuits SCna and SCnb can be synchronized with timings of a gate on voltage and a gate off voltage of the first emission control signal EM(n) input to the first pixel circuits Pn. Further, timings of a gate on voltage and a gate off voltage of the first scan signal S(n) output from each of the first and second division scan circuits SCna and SCnb can be synchronized with each other.

In an embodiment, a plurality of scan circuits connected to a gate line GL of the same sequence number can output scan signals of the same phase, and a plurality of pixel circuits connected to a gate line GL of the same sequence number can receive scan signals of the same phase to operate, thereby minimizing RC delay. Moreover, a plurality of scan circuits and a plurality of pixel circuits connected to a gate line GL of the same sequence number can operate based on emission control signals of the same phase, and thus, a circuit configuration of each scan circuit can be more simplified.

Furthermore, in the first scan block SB1 and the second scan block SB2 of FIG. 2, like a method illustrated in FIG. 3, the second scan circuit SCn+1 connected to the second gate line GLn+1 can receive the second emission control signal EM(n+1) which is sequentially input after the first emission control signal EM(n) and receives from the second emission signal line ELn+1 and can thus generate the second scan signal S(n+1) to output the second scan signal S(n+1) to the second gate line GLn+1. Here, the second scan circuit SCn+1 can also receive the first scan signal S(n) of a previous sequence number to generate the second scan signal S(n+1).

Moreover, the second pixel circuits Pn+1 electrically connected to the second gate line GLn+1 can receive the second scan signal S(n+1) and the second emission control signal EM(n+1) to control the emission of light by a light emitting device included in each of the second pixel circuits Pn+1. The second pixel circuits Pn+1 can further receive the first scan signal S(n) of a previous sequence number to control the emission of light by the light emitting device. At this time, timings of a gate on voltage and a gate off voltage of the second emission control signal EM(n+1) input to the second scan circuit SCn+1 can be synchronized with timings of a gate on voltage and a gate off voltage of the second emission control signal EM(n+1) input to each of the second pixel circuits Pn+1.

In FIG. 4, the first scan circuit SCn can be one of a plurality of scan circuits connected to the first gate line GLn. For example, in FIG. 2, the first scan circuit SCn can be one of the first division scan circuit SCna and the second division scan circuit SCnb. Similarly, the second scan circuit SCn+1 can be a scan circuit which is disposed in the same block as the first scan circuit SCn and is connected to the second gate line GLn+1 of a sequence number next to the first gate line GLn. In operation, the first scan circuit SCn can receive a previous scan signal S(n−1) of a previous sequence number and the first emission control signal EM(n) of a current sequence number to generate the first scan signal S(n) and can output the first scan signal S(n) to the first gate line GLn and the second scan circuit SCn+1. Similarly, the second scan circuit SCn+1 can receive the first scan signal S(n) of a previous sequence number and the second emission control signal EM(n+1) of a current sequence number to generate the second scan signal S(n+1) and can output the second scan signal S(n+1) to the second gate line GLn+1 and the third scan circuit SC (for example, SCn+2 of FIG. 2). Further, the plurality of scan circuits SCn to SCn+1 respectively connected to the plurality of gate lines GLn to GLn+4 which are sequentially arranged can be dependently connected to each other and can sequentially supply the plurality of scan signals S(n) to S(n+4) to the plurality of gate lines GLn to GLn+4 based on a shift clock timing.

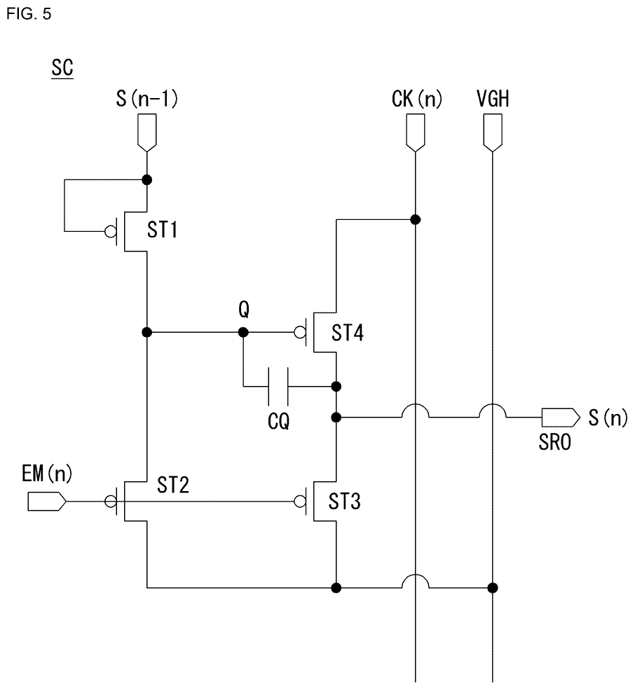

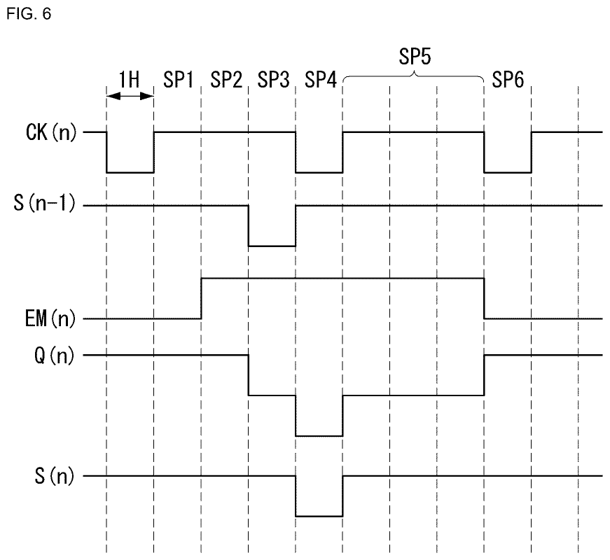

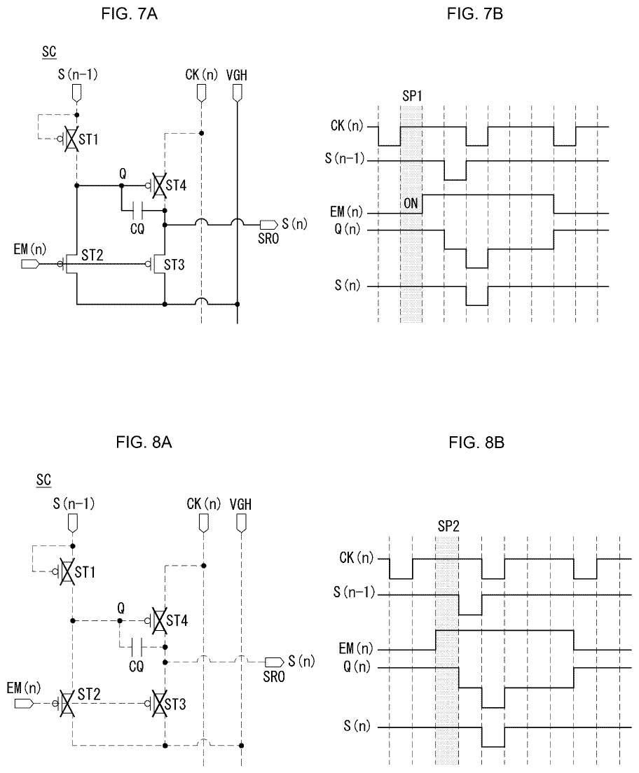

Hereinafter, a configuration of the scan circuit SC described above with reference to FIGS. 2 to 4 will be described. FIG. 5 is a diagram illustrating a first embodiment of a scan circuit SC according to the present disclosure, FIG. 6 is a diagram illustrating an example of a scan timing diagram for operating the scan circuit SC illustrated in FIG. 5, and FIGS. 7 to 12 are diagrams illustrating in detail an operating method of a first embodiment of the scan circuit SC illustrated in FIG. 5 based on the timing diagram illustrated in FIG. 6.

In FIG. 5, an example where the scan circuit SC is connected to a first gate line GLn among the plurality of scan circuits SC described above with reference to FIGS. 2 to 4 is illustrated, but the scan circuit SC can be applied to each of the plurality of scan circuits SC described above with reference to FIGS. 2 to 4.

Hereinafter, a previous scan signal S(n−1) can denote a scan signal which is first generated and input from another scan circuit instead of a corresponding scan circuit, and a current scan signal can denote a scan signal which is generated and output by a corresponding scan signal according to control based on the previous scan signal S(n−1) and an emission control signal. Also, an example will be described where a scan circuit is the first scan circuit SCn of FIGS. 2 to 4, a previous scan signal is S(n−1), a current scan signal is a first scan signal S(n), and an emission control signal is a first emission control signal BM(n).

The scan circuit SC according to the first embodiment can include a capacitor CQ, a first transistor ST1, a second transistor ST2, a third transistor ST3, and a fourth transistor ST4. The capacitor CQ can be connected to a first node Q at one end thereof, and the other end thereof can be connected to an output terminal SRO. The output terminal SRO can be connected to a gate line GL. For example, when a first scan circuit SCn outputs a first scan signal S(n), the output terminal SRO can be connected to a first gate line GLn.

Further, the first transistor ST1 can be connected to the first node Q at one end thereof and can receive a previous scan signal S(n−1) through the other end thereof, and thus, can charge a voltage of the previous scan signal S(n−1) in the first node Q. Similarly, the second transistor ST2 can be connected to the first node Q at one end thereof, an initialization voltage VGH can be supplied to the other end thereof, and the second transistor ST2 can supply the initialization voltage VGH to the first node Q according to a first emission control signal EM(n) of a current sequence number. Here, the initialization voltage VGH can be a gate off voltage. In FIG. 5, all transistors configuring the scan circuit SC can be a p type, and thus, an example where the initialization voltage VGH is a gate high voltage VGH is illustrated. However, the present disclosure is not limited thereto.

Next, the third transistor ST3 can be connected to a node between the output terminal SRO, the capacitor CQ, and the fourth transistor ST4 at one end thereof, the initialization voltage VGH can be supplied to the other end thereof, and the third transistor ST3 can supply the initialization voltage VGH to the other end of the capacitor CQ according to the emission control signal. In operation, the second and third transistors ST2 and ST3 can be turned on based on the first emission control signal EM(n) and can supply the gate high voltage VGH to the one end and the other end of the capacitor CQ to initialize the capacitor CQ. Also, the fourth transistor ST4 can receive a clock signal CK(n) through one end thereof and can be connected to the output terminal SRO at the other end thereof. Also, the fourth transistor ST4 can be turned on based on a voltage of the first node Q and can bootstrap a voltage of the clock signal CK(n) to generate a first scan signal S(n) of a current sequence number and can output the first scan signal S(n) to the output terminal SRO.

In FIG. 5, all of the first, second, third, and fourth transistors included in the scan circuit SC can be a p type, and thus, a gate on voltage can be a gate low voltage, and a gate off voltage can be a gate high voltage. However, the circuit of FIG. 5 can be one embodiment, and all of the first, second, third, and fourth transistors can be formed as an n type. In the situation of n type transistors, a gate on voltage can be a gate high voltage, and a gate off voltage can be a gate low voltage. Hereinafter, as in FIG. 5, a timing diagram of an example where all of first, second, third, and fourth transistors are provided as a p type will be described for example. The scan circuit SC illustrated in FIG. 5 can operate according to an embodiment of the timing diagram illustrated in FIG. 6, which illustrates an operating method of a scan circuit SC that includes a first initialization period SP1, a first holding period SP2, a charge period SP3, a scan output period SP4, a second holding period SP5, and a second initialization period SP6. In FIG. 6, each of the first initialization period SP1 and the second initialization period SP6 is illustrated, but the first and second initialization periods SP1 and SP2 can be integrated as one circuit operation. Also, the first holding period SP2 and the second holding period SP5 can be omitted. As described above, in the timing diagram of FIG. 6, a gate off voltage can be a gate high voltage, and a gate on voltage can be a gate low voltage.

As with the transistors used in pixel circuits, the transistors of any scan circuit described herein can be implemented with any of LTPS, oxide, or any other type of thin film transistors based on an organic or inorganic substrate. Also, driving transistors can be implemented with complementary metal oxide semiconductor (CMOS) transistors.

Turning to FIG. 7(a) and 7(b), in the first initialization period SP1, the first emission control signal EM(n) can have a gate low voltage which is a gate on voltage, and the other clock signal CK(n) and previous scan signal S(n−1) can have a gate high voltage which is a gate off voltage. Therefore, the first and fourth transistors ST1 and ST4 can be turned off, and the second and third transistors ST2 and ST3 can be turned on based on a gate on voltage of the first emission control signal EM(n) and can initialize the first node Q into the initialization voltage VGH. In other words, the second and third transistors ST2 and ST3 can supply the initialization voltage VGH to the one end and the other end of the capacitor CQ to initialize voltages at both ends of the capacitor CQ into a gate off voltage. Accordingly, a gate high voltage which is the initialization voltage VGH can be output as a current scan signal S(n) to the output terminal SRO, and the output current scan signal S(n) can have a gate high voltage.

Next, as shown in FIG. 8(a) and 8(b), in the first holding period SP2, the first emission control signal EM(n), the clock signal CK(n), and the previous scan signal S(n−1) can all have a gate off voltage. Accordingly, the first to fourth transistors ST1 to ST4 can be turned off, and both ends of the capacitor CQ can be floated and can maintain an initialization state.

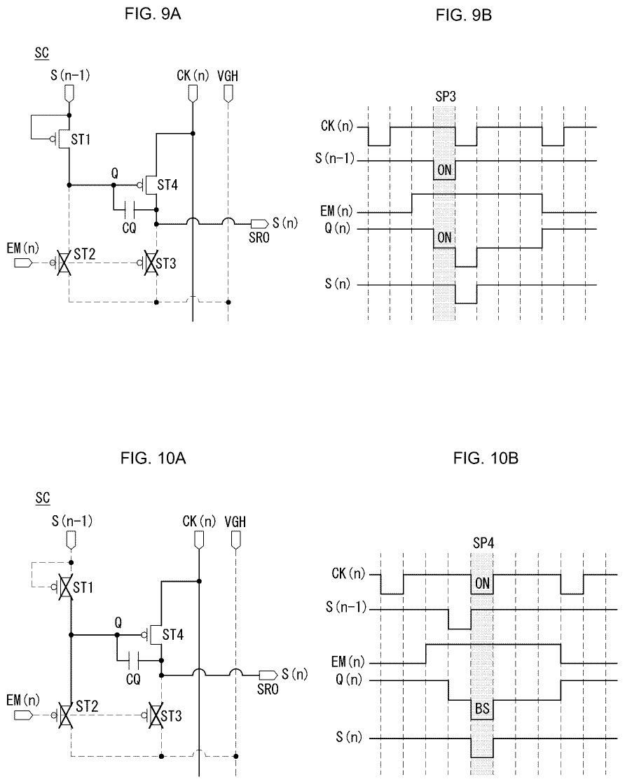

Then, as shown in FIG. 9(a) and 9(b),, in the chare period SP3, the previous scan signal S(n−1) can have a gate on voltage, and the clock signal CK(n) and the first emission control signal EM(n) can have a gate off voltage. Therefore, the second, third, and fourth transistors ST2, ST3, and ST4 can be turned off, and the first transistor ST1 can be turned on based on a gate on voltage of the previous scan signal S(n−1) and can charge the first node Q with the gate on voltage of the previous scan signal S(n−1). Accordingly, the fourth transistor ST4 can be turned on by a gate on voltage of the first node Q. Accordingly, a gate high voltage of the clock signal CK(n) can be output as the current scan signal S(n), and the output current scan signal S(n) can have a gate high voltage.

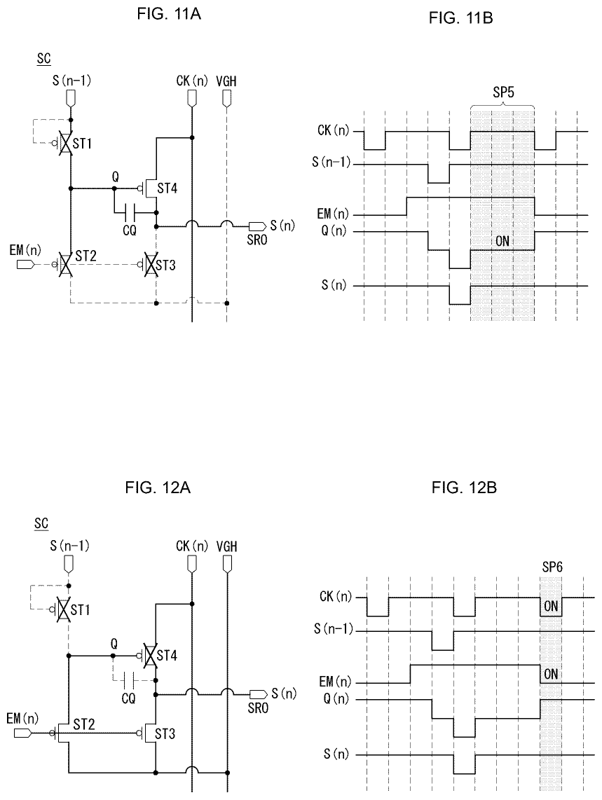

Continuing to FIG. 10(a) and 10(b), in the scan output period SP4, the clock signal CK(n) can have a gate on voltage, and the previous scan signal S(n−1) and the first emission control signal EM(n) can have a gate off voltage. Therefore, the first, second, and third transistors ST1, ST2, and ST3 can be turned off, and the fourth transistor ST4 can maintain a turn-on state based on a gate on voltage of the previous scan signal S(n−1) charged in the first node Q. Furthermore, the fourth transistor ST4 can receive the clock signal CK(n) of a gate on voltage through one end thereof, and as a voltage of the clock signal CK(n) is added to a voltage of the previous scan signal S(n−1), a voltage of the first node Q can be bootstrapped, a bootstrapped voltage can be output to the current scan signal S(n) through the output terminal SRO, and the output current scan signal S(n) can have a gate low voltage.

Next, in FIG. 11(a) and 11(b), in the second holding period SP5, the clock signal CK(n), the previous scan signal S(n−1), and the first emission control signal EM(n) can have a gate off voltage. Therefore, the first, second, and third transistors ST1, ST2, and ST3 can be turned off, and the fourth transistor ST4 can maintain a turn-on state based on the gate on voltage of the previous scan signal S(n−1) charged in the first node Q. On the other hand, as the clock signal CK(n) has a gate off voltage, the output terminal SRO can output the gate off voltage of the clock signal CK(n) as the current scan signal S(n), and the output current scan signal S(n) can have a gate high voltage.

Then, in FIG. 12(a) and 12(b), in the second initialization period SP6, the first emission control signal EM(n) and the clock signal CK(n) can have a gate on voltage, and the previous scan signal S(n−1) can have a gate off voltage. Therefore, the first and fourth transistors ST1 and ST4 can be turned off, and the second and third transistors ST2 and ST3 can be turned on based on a gate on voltage of the first emission control signal EM(n) and can initialize a node connected to the output terminal SRO and the first node Q into the initialization voltage VGH. In other words, the second and third transistors ST2 and ST3 can supply the initialization voltage VGH to the one end and the other end of the capacitor CQ to initialize voltages at both ends, charged in the capacitor CQ, into a gate off voltage. As the first node Q has the initialization voltage VGH which is a gate off voltage, the fourth transistor ST4 can be turned off, and thus, even when the clock signal CK(n) has a gate on voltage, the clock signal CK(n) may not be output. On the other hand, the initialization voltage VGH can be supplied to the node connected to the output terminal SRO, and thus, the initialization voltage VGH can be output to the output terminal SRO. Therefore, the current scan signal S(n) output to the output terminal SRO can have a gate high voltage.

As described above, in the first embodiment of the scan circuit SC according to the present disclosure, the scan circuit SC can be configured with one capacitor CQ and four transistors ST1 to ST4, and thus, one scan circuit SC can be disposed in one scan circuit area AS where a space is very narrow. Moreover, in the first embodiment of the scan circuit SC according to the present disclosure, a separate clock signal may not be used for controlling gates of the second and third transistors ST2 and ST3, and an emission control signal used in the pixel circuit P can be used as a gate control signal for the second and third transistors ST2 and ST3, and thus, the number of lines for supplying the clock signal can be reduced, thereby more simplifying a structure of a circuit line.

In contrast, in related art, a plurality of scan circuit areas AS can be needed for configuring one scan circuit SC for supplying a scan signal to one gate line GL. For example, in related art, a transistor connected to a Q node can be disposed in one scan circuit area, a transistor connected to a QB node can be disposed in the other one scan circuit area, a transistor connected to an output terminal can be disposed in the other one scan circuit area, and thus, one scan circuit SC can be configured, and a node line for connecting each node of one scan circuit disposed in each scan circuit area can be disposed across a plurality of pixel circuits. In this situation, coupling between the pixel circuit P and a node line configuring one scan circuit SC can occur, and due to this, an operation of the pixel circuit P can be stabilized, or an operation error can occur.

In contrast, the present disclosure provides an advantageous arrangement where circuit configuration can be simplified, and thus, one scan circuit SC can be disposed in one scan circuit area AS thereby allowing a node line disposed across a pixel to be omitted. Accordingly, coupling between the scan circuit SC and the pixel circuit P can be minimized, and an operation stability of a panel can be more enhanced.

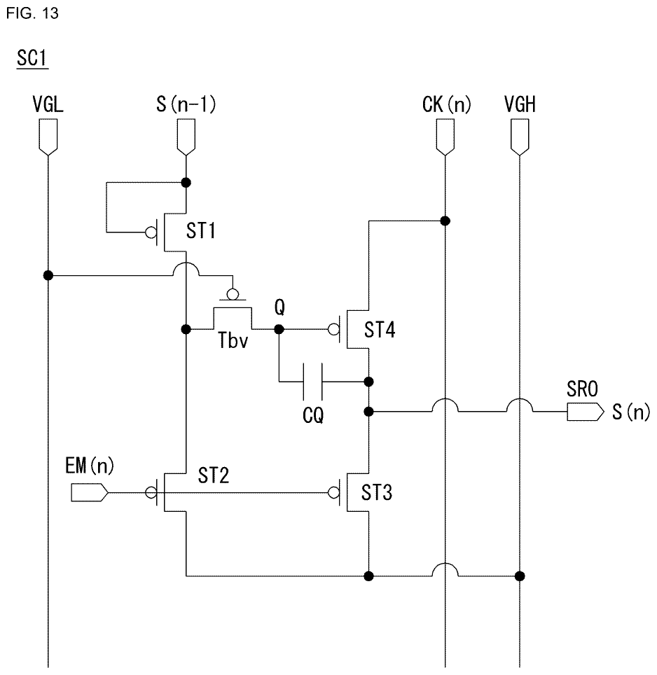

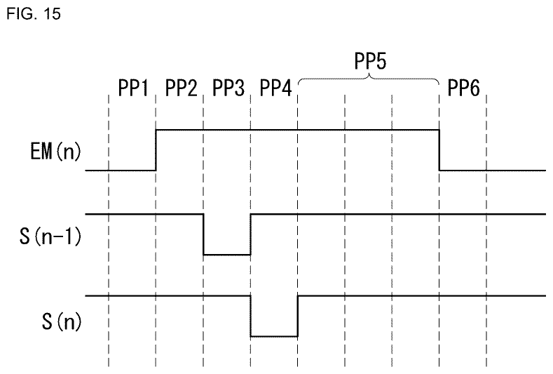

Next, FIG. 13 is a diagram illustrating a second embodiment of a scan circuit according to the present disclosure. In FIG. 13, descriptions which are the same as the descriptions of FIG. 5 can be omitted, and different elements can be mainly described. As illustrated in FIG. 13, a second embodiment of a scan circuit SC can include a capacitor CQ, first to fourth transistors ST1 to ST4, and a fifth transistor ST5. Here, descriptions of the capacitor CQ and the first to fourth transistors ST1 to ST4 can be replaced with the descriptions of FIG. 5. Also, the fifth transistor ST5 can be connected between the first and second transistors ST1 and ST2 and a first node Q. In other words, one end of the fifth transistor ST5 can be connected between the first transistor ST1 and the second transistor ST2, the other end thereof can be connected to the first node Q, and a gate on voltage (for example, a gate low voltage VGL) can be supplied to a gate thereof. In view of FIG. 15, because the fifth transistor ST5 is a p type, an example where a gate on voltage (a gate low voltage VGL) is supplied to the gate of the fifth transistor ST5 is illustrated However, when the fifth transistor ST5 is an n type, a gate high voltage VGH can be supplied as a gate on voltage.

In operation, the fifth transistor ST5 can maintain a turn-on state in the other period except an output period based on a gate on voltage. However, while an electric potential of the first node Q is being bootstrapped in the output period, a gate-source voltage of the fifth transistor ST5 can be lower than a threshold voltage, and thus, the fifth transistor ST5 can be turned off. Accordingly, the fifth transistor ST5 can be turned off while an electric potential of the first node Q is being bootstrapped, and thus, can cut off a current path between the first and second transistors ST1 and ST2 and the first node Q. Therefore, a device breakdown phenomenon where the first transistor ST1 or the second transistor ST2 is broken down by a high electric potential of the first node Q can be prevented, thereby enhancing the stability of the scan circuit SC.

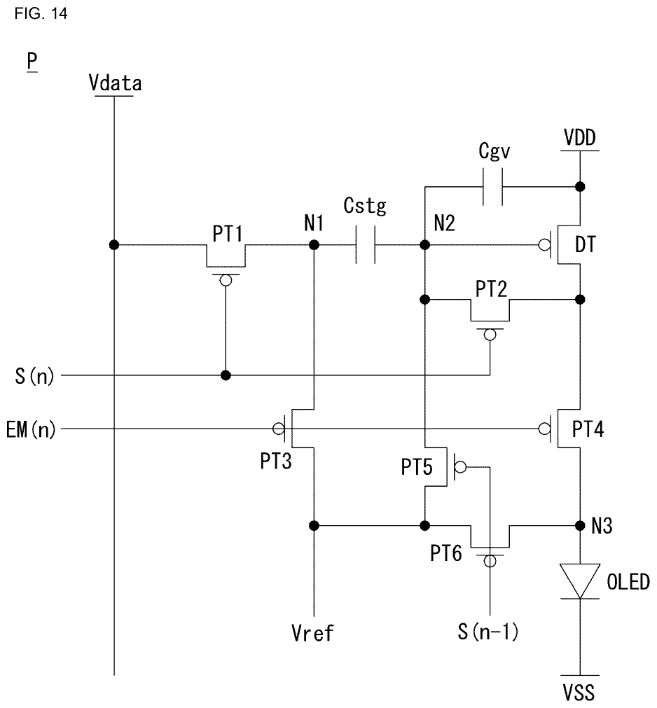

Turning to FIG. 14, a diagram illustrating an example of a pixel circuit P, and FIG. 15 is a diagram illustrating an example of a pixel timing diagram for operating the pixel circuit P illustrated in FIG. 14. As illustrated in FIG. 14, an example of the pixel circuit P according to the present disclosure can be supplied with a current scan signal S(n), an emission control signal EM(n), and a previous scan signal S(n−1) and can convert a data voltage Vdata, which is input in synchronization with the current scan signal S(n), into a driving current, and thus, can control the emission of light by a light emitting device OLED. If the pixel circuit P illustrated in FIG. 14 receives the current scan signal S(n) and the emission control signal EM(n) to operate, a structure of a circuit can be sufficiently modified. Hereinafter, for convenience of description, the pixel circuit P illustrated in FIG. 14 will be described for example.

Also, as illustrated in FIG. 14, an example of the pixel circuit P according to the present disclosure can include a light emitting device OLED, first to sixth pixel transistors PT1 to PT6, a driving transistor DT, and first and second pixel capacitors Cstg and Cgv. Further, while FIG. 14 provides an example where the first to sixth pixel transistors PT1 to PT6 and the driving transistor DT are a p type is illustrated, the present disclosure is not limited thereto and at least some transistors can be an n type. Hereinafter, based on the illustration of FIG. 14, an example where a gate on voltage is a gate low voltage and a gate off voltage is a gate high voltage will be described.

As is shown in FIG. 14, the driving transistor DT can be supplied with a high-level voltage VDD through one end thereof, the light emitting device OLED can be connected to the other end thereof, and a gate electrode thereof can be connected to a second pixel node N2. In operation, the driving transistor DT can generate a driving current Ioled to supply the driving current to the light emitting device OLED based on a voltage stored in the second pixel node N2. Also, the first pixel capacitor Cstg can be connected between the first pixel node N1 and the second pixel node N2, and the second pixel capacitor Cgv can be connected between the one end of the driving transistor DT and the second pixel node N2.

In addition, the first pixel transistor PT1 can be supplied with a data voltage Vdata through one end thereof, the other end thereof can be connected to the first pixel node N1, and a current scan signal S(n) can be applied to a gate electrode thereof. The first pixel transistor PT1 can apply the data voltage Vdata, supplied through the one end thereof, to the first pixel node N1 according to the current scan signal S(n). The second pixel transistor PT2 can be connected to the other end of the driving transistor DT at one end thereof, the other end thereof can be connected to the second pixel node N2, and the current scan signal S(n) can be applied to a gate electrode thereof. The second pixel transistor PT2 can diode-connect the gate electrode and the other end of the driving transistor DT with each other, the current scan signal S(n), and thus, can allow an electrical characteristic variation of the driving transistor DT not to affect an emission current.

Further, the third pixel transistor PT3 can be supplied with a reference voltage Vref through one end thereof, the other end thereof can be connected to the first pixel node N1, and an emission control signal EM(n) can be applied to a gate electrode thereof. Accordingly, the third pixel transistor PT3 can supply the reference voltage Vref to the first pixel node N1 to initialize the first pixel node N1 based on the emission control signal EM(n). Still further, the fourth pixel transistor PT4 can be connected to the other end of the driving transistor DT at one end thereof, the other end thereof can be connected to the third pixel node N3, and the emission control signal EM(n) can be applied to a gate electrode thereof. Accordingly, the fourth pixel transistor PT4 can allow a driving current generated from the driving transistor DT to be supplied to the light emitting device OLED connected to the third pixel node N3 based on the emission control signal EM(n).

Next, the fifth pixel transistor PT5 can be supplied with the reference voltage Vref through one end thereof, the other end thereof can be connected to the second pixel node N2, and a previous scan signal S(n−1) can be applied to a gate electrode thereof. Accordingly, the fifth pixel transistor PT5 can supply the reference voltage Vref to the second pixel node N2 to initialize the second pixel node N2 based on the previous scan signal S(n−1). Next, the sixth pixel transistor PT6 can be supplied with the reference voltage Vref through one end thereof, the other end thereof can be connected to the third pixel node N3, and the previous scan signal S(n−1) can be applied to a gate electrode thereof. Thus, the sixth pixel transistor PT6 can supply the reference voltage Vref to the third pixel node N3 to initialize an anode electrode of the light emitting device OLED connected to the third pixel node N3 based on the previous scan signal S(n−1).

In a number of embodiments, the light emitting device OLED can be implemented as an organic light emitting diode OLED, the anode electrode thereof can be connected to the third pixel node N3, and a cathode electrode thereof can be connected to a low-level voltage VSS. In operation, the light emitting device OLED can be turned on based on the driving current supplied from the driving transistor DT and can emit light.

The pixel circuit P illustrated in FIG. 14 can be driven according to a timing diagram illustrated in FIG. 15, which is a driving method of a pixel circuit P including a previous emission period PP1, a first pixel holding period PP2, a pixel initialization period PP3, a programming period PP4, a second pixel holding period PP5, and a current emission period PP6. In FIG. 15, comparing with the scan timing diagram described above with reference to FIG. 6, a timing diagram of the pixel circuit P including the previous emission period PP1 is illustrated, but a period where the pixel circuit P is driven can include the first pixel holding period PP2, the pixel initialization period PP3, the programming period PP4, the second pixel holding period PP5, and the current emission period PP6. Furthermore, the first pixel holding period PP2 and the second pixel holding period PP5 can be omitted in FIG. 5.

Hereinafter, for convenience of description, the driving method of the pixel circuit P illustrated in FIG. 14 will be described with reference to the timing diagram illustrated in FIG. 15 for example. In FIG. 15, the previous emission period PP1 can be a period where the light emitting device OLED emits light a data voltage Vdata which is input in synchronization with the previous scan signal S(n−1). In the previous emission period PP1, the emission control signal EM(n) can have a gate low voltage which is a gate on voltage, and the previous scan signal S(n−1) and the current scan signal S(n) can have a gate high voltage which is a gate off voltage. Therefore, the third and fourth pixel transistors PT3 and PT4 can be turned on, the first, second, fifth, and sixth pixel transistors PT1, PT2, PT5, and PT6 can be turned off, and the driving transistor DT can generate the driving current with a voltage which is programmed in the second pixel node N2. Accordingly, in the previous emission period PP1, the reference voltage Vref can be supplied to the first pixel node N1 to initialize the first pixel node N1, and the light emitting device OLED can emit light with the driving current generated from the driving transistor DT.

Next, in the first pixel holding period PP2, the emission control signal EM(n), the previous scan signal S(n−1), and the current scan signal S(n) can have a gate off voltage. Accordingly, the first to sixth pixel transistors PT1 to PT6 can be turned off, and moreover, the light emitting device OLED may not be supplied with the driving current and can thus be turned off.

Then, in the pixel initialization period PP3, the previous scan signal S(n−1) can have a gate on voltage, and the emission control signal EM(n) and the current scan signal S(n) can have a gate off voltage. Therefore, the fifth and sixth pixel transistors PT5 and PT6 can be turned on, and the first to fourth pixel transistors PT1 to PT4 can be turned off. Accordingly, a voltage of the reference voltage Vref can be supplied to the second pixel node N2 and the third pixel node N3 through the fifth and sixth pixel transistors PT5 and PT6. As a result, the first and second capacitors Cstg and Cgv connected to the second pixel node N2 can be charged with the voltage of the reference voltage Vref and can thus be initialized, and the voltage of the reference voltage Vref can be supplied to the third pixel node N3 to initialize the anode electrode of the light emitting device OLED.

Next, in the programming period PP4, the previous scan signal S(n−1) can have a gate on voltage, and the emission control signal EM(n) and the current scan signal S(n) can have a gate off voltage. Therefore, the first and second pixel transistors PT1 and PT2 can be turned on, and the third to sixth pixel transistors PT3 to PT6 can be turned off. Accordingly, the data voltage Vdata can be supplied to the first pixel node N1, and the third pixel node N3 can be greater in voltage than a threshold voltage of the driving transistor DT as the data voltage Vdata is instantaneously added to the reference voltage Vref. As a result, the driving transistor DT can be turned on, and a high-level voltage VDD can be applied to the second pixel node N2 through the driving transistor DT and the second pixel transistor PT2, and thus, the threshold voltage of the driving transistor DT and the high-level voltage VDD can be reflected in the second pixel node N2. Therefore, in the programming period PP4, a programming voltage including the data voltage Vdata, the high-level voltage VDD, and the threshold voltage of the driving transistor DT can be stored in the second pixel node N2.

Subsequently, in the second pixel holding period PP5, the emission control signal EM(n), the previous scan signal S(n−1), and the current scan signal S(n) can have a gate off voltage. Accordingly, the first to sixth pixel transistors PT1 to PT6 can be turned off, and the driving transistor DT can maintain a turn-on state. However, the fourth pixel transistor PT4 can be in a turn-on state, and thus, the light emitting device OLED may not be supplied with the driving current and can thus maintain a turn-off state.

Then, in the current emission period PP6, the emission control signal EM(n) can have a gate on voltage, and the previous scan signal S(n−1) and the current scan signal S(n) can have a gate off voltage. Accordingly, the third and fourth pixel transistors PT3 and PT4 can be turned on, and the driving current generated by the driving transistor DT can be supplied to the light emitting device OLED, and thus, the light emitting device OLED can emit light. In operation, a magnitude of the driving current can be determined based on the programming voltage stored in the second pixel node N2. The programming voltage can be reflected in the threshold voltage of the driving transistor DT, and thus, when the driving current is generated, the threshold voltage can be offset. Therefore, the driving transistor DT can generate, as the driving current, a current based on a difference voltage between the data voltage Vdata and the voltage Vref of a reference power source. Accordingly, the light emitting device OLED can determine the intensity of light emitted based on a magnitude of the driving current.

Next, the pixel circuit P described above with reference to FIGS. 14 and 15 can be supplied with the emission control signal EM(n) supplied to the scan circuit PC to operate. The structure and operating method of the pixel circuit P described above with reference to FIGS. 14 and 15 have been described as an example which is supplied with the previous scan signal S(n−1) and driven, but the structure and operating method of the pixel circuit P according to the present disclosure are not limited thereto and can be applied to a pixel circuit P which is supplied with only the emission control signal EM(n) and the current scan signal S(n) and driven. Also, timings of a gate on voltage and a gate off voltage of the emission control signal EM(n) supplied to the pixel circuit P according to the present disclosure can be synchronized with timings of a gate on voltage and a gate off voltage of the emission control signal EM(n) supplied to the scan circuit SC.

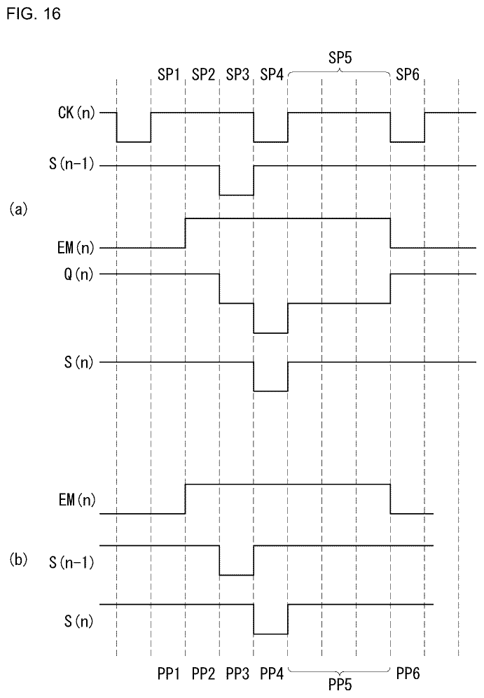

Next, FIG. 16(a) and 16(b) illustrate a comparison of the timing diagram of FIG. 6 and the pixel timing diagram of FIG. 15. More specifically, FIG. 16(a) is a timing diagram of a signal applied to the scan circuit SC, and FIG. 16(b) is a timing diagram of a signal supplied to the pixel circuit P. For example, FIG. 16(a) can be a timing diagram of the first scan circuit SCn which outputs the first scan signal S(n), and FIG. 16(b) can be a timing diagram of the first pixel circuit Pn which receives the first scan signal S(n) through the first gate line GLn. Here, the first scan circuit SCn can include the first and second division scan circuits SCna and SCnb described above with reference to FIG. 2. As illustrated in FIG. 16(a) and 16(b), timings of a gate on voltage and a gate off voltage of the emission control signal EM(n) supplied to the first scan circuit SCn can be synchronized with timings of a gate on voltage and a gate off voltage of the emission control signal EM(n) supplied to the first pixel circuit Pn.

In detail, a timing at which the emission control signal EM(n) supplied to the first scan circuit SCn increases from gate low voltage to a gate high voltage and decreases from gate high voltage to a gate low voltage of FIG. 16(a) can be the same as a timing at which the emission control signal EM(n) supplied to the first pixel circuit Pn increases from gate low voltage to a gate high voltage and decreases from gate high voltage to a gate low voltage of FIG. 16(b). For example, a first holding period SP2, a charge period SP3, a scan output period SP4, and a second holding period SP5, where the emission control signal EM(n) supplied to the first scan circuit SCn maintains a gate off voltage in a scan circuit SC timing diagram illustrated in (a), can be the same as a first pixel holding period PP2, a pixel initialization period PP3, a programming period PP4, and a second pixel holding period PP5, where the emission control signal EM(n) supplied to the first pixel circuit Pn maintains a gate off voltage in a pixel circuit P timing diagram illustrated in (b).

Moreover, timings of a gate on voltage and a gate off voltage of the previous scan signal S(n−1) supplied to the first scan circuit SCn can be synchronized with timings of a gate on voltage and a gate off voltage of the previous scan signal S(n−1) supplied to the first pixel circuit Pn. For example, the charge period SP3 where the previous scan signal S(n−1) supplied to the first scan circuit SCn maintains a gate on voltage in the scan circuit SC timing diagram illustrated in (a) can be the same as the pixel initialization period PP3 where the previous scan signal S(n−1) supplied to the first pixel circuit Pn maintains a gate on voltage in the pixel circuit P timing diagram illustrated in (b).

In addition, timings of a gate on voltage and a gate off voltage of the current scan signal S(n) supplied to the first scan circuit SCn can be synchronized with timings of a gate on voltage and a gate off voltage of the current scan signal S(n) supplied to the first pixel circuit Pn. For example, an output period where the first scan circuit SCn outputs the first scan signal S(n) in the scan circuit SC timing diagram illustrated in (a) can be the same as the programming period PP4 where the first scan signal S(n) is supplied to the first pixel circuit Pn in the pixel circuit P timing diagram illustrated in (b).

As described above, in an embodiment, the scan circuit SC can receive the emission control signal EM(n) supplied to the pixel circuit P and can use the emission control signal as a control signal for generating a scan signal, and thus, can be simplified. In an embodiment, as the scan circuit SC is simplified, coupling between the scan circuit SC and the pixel circuit P can be minimized, and a defect occurrence rate caused by coupling can be reduced.

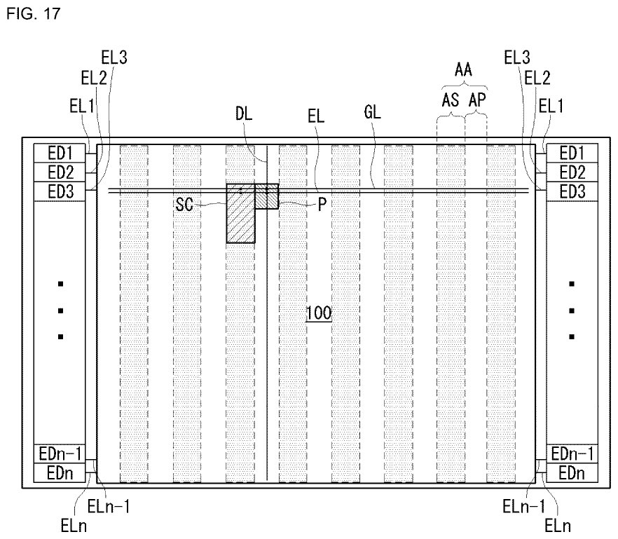

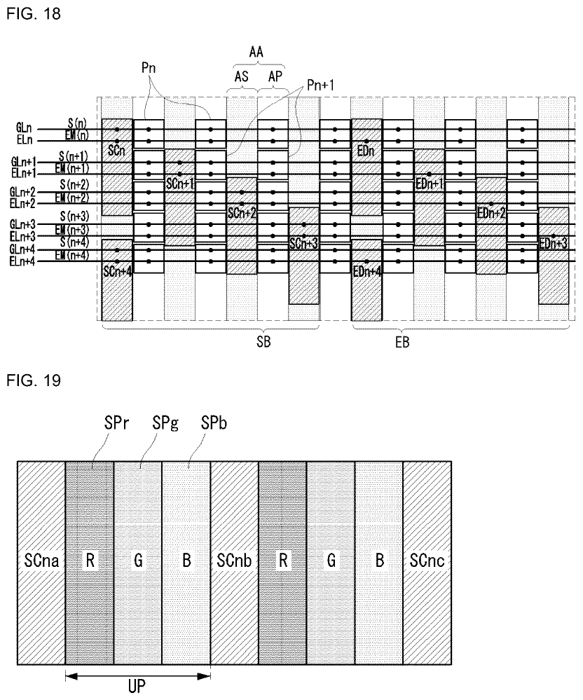

Hereinafter, a configuration example of an EM driver 140 will be described with respect to FIGS. 17 and 18, which is a diagram illustrating an example where an EM driver of FIG. 1 is disposed in a non-active area, and FIG. 18 is a diagram illustrating an example where an EM driver is disposed in an active area. As illustrated in FIG. 17, a plurality of EM drivers including ED1 to EDn can be provided in non-active areas NA disposed at both edges of the display panel 100. Also, the plurality of EM drivers ED1 to EDn can be electrically connected to a plurality of emission signal lines EL1 to ELn. For example, the EM drivers ED1 to EDn can be respectively and electrically connected to the emission signal lines EL1 to ELn. Further, the EM drivers ED1 to EDn can respectively and sequentially supply an emission control signal to the emission signal lines EL1 to ELn. Still further, an emission control signal EM(n) supplied by each of the EM drivers ED1 to EDn can be supplied to a scan circuit SC and a pixel circuit P, which are disposed in an active area AA. For example, the EM driver ED3 can output the emission control signal through the emission signal line EL3 to supply the emission control signal to the scan circuit SC and the pixel circuit P electrically connected to the emission signal line EL3.

Unlike FIG. 17, as illustrated in FIG. 18, a plurality of EM drivers (for example, EDn to EDn+4) can be disposed in a plurality of scan circuit areas AS in the active area AA of the display panel 100 and can be respectively and electrically connected to the emission signal lines ELn to ELn+4. Also, the plurality of EM drivers (for example, EDn to EDn+4) can respectively and sequentially output emission control signals EM(n) to EM(n+4) to the emission signal lines ELn to ELn+4 to supply the emission control signals EM(n) to EM(n+4) to a plurality of scan circuits SCn to SCn+4 disposed in the scan circuit area AS and a plurality of pixels P disposed in a pixel area AP. For example, the EM driver EDn can output the emission control signal EM(n) to the emission signal line ELn to supply the emission control signal EM(n) to a scan circuit SCn and a pixel circuit Pn electrically connected to the emission signal line ELn.

Further, as illustrated in FIG. 18, an EM block EB including a plurality of EM drivers can be disposed in parallel with each scan block SB including a plurality of scan circuits. For example, when n number of scan blocks SB is provided in the display panel, the number of EM blocks EB can be an n number. However, the present disclosure is not limited thereto, and in the display panel, the number of scan blocks SB can differ from the number of EM blocks EB.

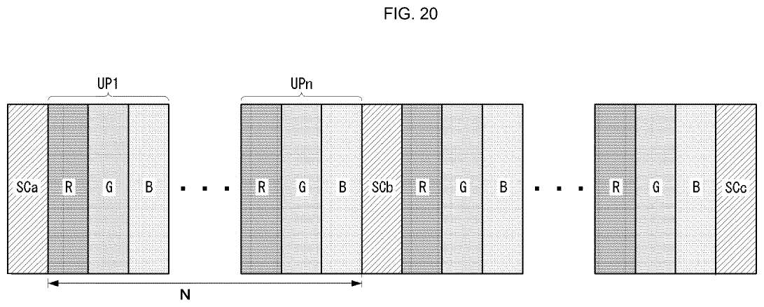

Next, FIGS. 19 and 20 are diagrams illustrating the number of scan circuits connected to one gate line. In FIGS. 19 and 20, it can be assumed a scan circuit is connected to each subpixel through the same gate line GL. Also, as illustrated in FIG. 19, one unit pixel UP can include red (R), green (G), and blue (B) subpixels SPr, SPg, and SPb. Further, scan circuits (for example, SCna, SCnb, and SCnc) according to the present disclosure can be provided for each unit pixel. For example, one unit pixel UP can be disposed between the scan circuit SCna and the scan circuit SCnb, and one unit pixel UP can be disposed between the scan circuit SCnb and the scan circuit SCnc.

However, when one scan circuit is provided for each unit pixel, the number of scan circuits can increase excessively, and due to this, a load caused by the number of clock signal lines can increase excessively. In other words, each scan circuit can need a clock signal for generating a scan signal, and as the number of scan circuits increases, the number of clock signal lines can increase, causing an excessive increase in load due to an increase in number of clock signal lines. Moreover, unlike the illustration of FIG. 19, in an example where one scan circuit is disposed in one gate line, a length of a gate line connected to the one scan circuit can increase excessively, and due to this, a load applied to a scan line can increase, causing the turn-on voltage drop of a scan signal.

Also, as described above, the number of scan circuits connectable to one gate line can be one to the number of unit pixels, but based on an increase in load of a gate line and an increase in clock load caused by an increase in number of clock signal lines, the present disclosure can appropriately place a number of scan circuits connected to one gate line. For example, as illustrated in FIG. 20, in a situation where a plurality of scan circuits (for example, SCna, SCnb, and SCnc) are connected to one gate line, the number N of unit pixels UP1 to UPn disposed between adjacent scan circuits of the scan circuits (for example, SCna, SCnb, and SCnc) can be 80 to 100 based on a magnitude of a load based on the number of clock signal lines, a magnitude of the turn-on voltage drop of a scan signal, and the number of pixels connected to one gate line. However, the present disclosure is not limited to the number N of unit pixels UP1 to UPn disposed between a plurality of scan circuits (for example, SCna, SCnb, and SCnc). For example, the number N of pixels can be changed based on a size, a PPI (pixels per inch), and an arrangement design of a display panel.

Further, as described above, in an embodiment, a scan circuit can receive an emission control signal supplied to a pixel circuit and can use the emission control signal as a control signal for generating a scan signal, and thus, can be simplified. Thus, the scan circuit can be simplified, coupling between the scan circuit and a pixel circuit can be minimized, and a defect occurrence rate caused by coupling can be reduced.

As a variation of the organization of FIGS. 17 and 18, in still other examples the scan circuits, such as those found in FIG. 5 or 13, or scan circuits of other scan circuit designs that perform the same or similar functions, can be integrated in whole or at least in part with the various pixel areas AP. For example, third and fourth transistors ST3 and ST4 of the scan circuits of FIGS. 5 and 13 may be placed directly between the first and second transistors PT1 and PT2 of the pixel circuit of FIG. 14 for a given sub-pixel, or between transistors of sub-pixels of a single pixel. Similarly, all or a portion of the components of some or all of the EM drivers EDn to EDn+4 may be disposed within the various pixel areas AP. In such instances, the widths of scan areas AS may be reduced as compared to pixel areas AP.

In addition, the effects according to the present disclosure are not limited to the above examples, and other various effects can be included in the specification. While the present disclosure has been particularly shown and described with reference to exemplary embodiments thereof, it will be understood by those of ordinary skill in the art various changes in form and details can be made therein without departing from the spirit and scope as defined by the following claims.

What is claimed is:

1. A display panel comprising:
an active area including a plurality of pixel areas and a plurality of scan circuit areas disposed between the plurality of pixel areas;
a non-active area surrounding the active area and disposed between the active area and an edge of the display panel;
an emission driver configured to provide an emission control signal;
a plurality of pixel circuits disposed in the plurality of pixel areas and configured to control emission of lights by a plurality of light emitting devices based on the emission control signal; and
a plurality of scan circuits disposed in the plurality of scan circuit areas and configured to generate a scan signal which is to be supplied to the plurality of pixel circuits,
wherein the plurality of scan circuits receive the emission control signal to generate the scan signal.

2. The display panel of claim 1, further comprising:
a first division scan circuit disposed in a first scan circuit area of the plurality of scan circuit areas and electrically connected to a first gate line, wherein the first division scan circuit generates a first scan signal to output the first scan signal to the first gate line based on a first emission control signal; and
first pixel circuits respectively disposed in the plurality of pixel areas and electrically connected to the first gate line, wherein the first pixel circuits receive the first emission control signal and the first scan signal of the first division scan circuit to control emission of light by a light emitting device included in each of the first pixel circuits.

3. The display panel of claim 2, wherein timings of a gate on voltage and a gate off voltage of the first emission control signal input to the first division scan circuit are synchronized with timings of a gate on voltage and a gate off voltage of the first emission control signal input to the first pixel circuits.

4. The display panel of claim 2, further comprising:
a second division scan circuit disposed in a second scan circuit area spaced apart from the first scan circuit area among the plurality of scan circuit areas and electrically connected to the first gate line,
wherein the second division scan circuit generates the first scan signal to output the first scan signal to the first gate line based on the first emission control signal, and
wherein the first pixel circuits receive the first emission control signal and the first scan signal of the second division scan circuit to control emission of light by the light emitting device included in each of the first pixel circuits.

5. The display panel of claim 4, wherein timings of a gate on voltage and a gate off voltage of the first emission control signal input to the second division scan circuit are synchronized with timings of a gate on voltage and a gate off voltage of the first emission control signal input to the first pixel circuits.

6. The display panel of claim 4, wherein timings of a gate on voltage and a gate off voltage of the first scan signal output from the first division scan circuit is synchronized with timings of a gate on voltage and a gate off voltage of the first scan signal output from the second division scan circuit.

7. The display panel of claim 4, further comprising:
a second scan circuit electrically connected to a second gate line differing from the first gate line, wherein the second scan circuit receives a second emission control signal having a phase differing from a phase of the first emission control signal to generate a second scan signal having a phase differing from a phase of the first scan signal and output the second scan signal to the second gate line; and
second pixel circuits electrically connected to the second gate line, wherein the second pixel circuits receive the second scan signal and the second emission control signal to control emission of light by a light emitting device included in each of the second pixel circuits.

8. The display panel of claim 7, wherein timings of a gate on voltage and a gate off voltage of the second emission control signal input to the second scan circuit are synchronized with timings of a gate on voltage and a gate off voltage of the second emission control signal input to each of the second pixel circuits.

9. The display panel of claim 7, wherein the first scan signal output from the first division scan circuit or the second division scan circuit is input to the second scan circuit.

10. The display panel of claim 7, wherein the first scan signal output from the first division scan circuit or the second division scan circuit is input to each of the second pixel circuits.

11. The display panel of claim 1, wherein each of the plurality of scan circuits comprises:
a capacitor connected to a first node at one end thereof and connected to an output terminal at the other end thereof;
a first transistor connected to the first node at one end thereof and configured to receive a previous scan signal through the other end thereof to charge a voltage of the previous scan signal in the first node;
a second transistor supplied with an initialization voltage through one end thereof, connected to the first node at the other end thereof, and configured to supply the initialization voltage to the first node based on the emission control signal;
a third transistor supplied with the initialization voltage through one end thereof, connected to the first node at the other end thereof, and configured to supply the initialization voltage to the other end of the capacitor based on the emission control signal; and
a fourth transistor supplied with a clock signal through one end thereof, connected to the output terminal at the other end thereof, and configured to bootstrap a voltage of the clock signal to output a current scan signal to the output terminal based on a voltage of the first node.

12. The display panel of claim 11, wherein, in an initialization period, the second and third transistors are turned on based on a gate on voltage of the emission control signal and initializes the first node into the initialization voltage,
in a charge period, the first transistor is turned on based on a gate on voltage of the previous scan signal, charges the first node with a voltage of the previous scan signal, and turns on the fourth transistor, and
in an output period, the fourth transistor receives the clock signal and outputs the current scan signal generated through bootstrapping based on a voltage of the previous scan signal stored in the first node.

13. The display panel of claim 11, wherein each of the plurality of scan circuits further comprises a fifth transistor connected between the first transistor and the second transistor at one end thereof and connected to the first node at the other end thereof.

14. The display panel of claim 1, further comprising a non-active area disposed outside the active area,
wherein an EM driver supplying the emission control signal to the pixel circuit and the scan circuit is disposed in the non-active area.

15. A display apparatus comprising:
a display panel that includes an active area including a plurality of pixel areas and a plurality of scan circuit areas disposed between the plurality of pixel areas;
a non-active area surrounding the active area and disposed between the active area and an edge of the display panel;
an emission driver configured to provide an emission control signal;
a plurality of pixel circuits disposed in the plurality of pixel areas and configured to control emission of lights by a plurality of light emitting devices based on the emission control signal; and
a plurality of scan circuits disposed in the plurality of scan circuit areas and configured to receive the emission control signal and to generate a scan signal based on the emission control signal, and supply the scan signal to the plurality of pixel circuits,
wherein each of the plurality of pixel areas extend along a length direction and are spaced apart from each other in a second direction intersecting the length direction,
each of the plurality of scan circuit areas extend along the length direction and are spaced apart from each other in the second direction, and
at least one scan circuit is disposed directly between two pixel circuits.

16. The display apparatus of claim 15, wherein the emission driver supplying the emission control signal is disposed in the active area directly between at least two pixels.

17. The display apparatus of claim 15, wherein at least two scan circuits disposed in different scan areas drive a common gate line to supply a common scan signal.

18. The display apparatus of claim 15, further comprising:
a first division scan circuit disposed in a first scan circuit area of the plurality of scan circuit areas and electrically connected to a first gate line, wherein the first division scan circuit generates a first scan signal to output the first scan signal to the first gate line based on a first emission control signal; and
first pixel circuits respectively disposed in the plurality of pixel areas and electrically connected to the first gate line, wherein the first pixel circuits receive the first emission control signal and the first scan signal of the first division scan circuit to control emission of light by a light emitting device included in each of the first pixel circuits.

19. The display apparatus of claim 18, further comprising:
a second division scan circuit disposed in a second scan circuit area spaced apart from the first scan circuit area among the plurality of scan circuit areas and electrically connected to the first gate line,
wherein the second division scan circuit generates the first scan signal to output the first scan signal to the first gate line based on the first emission control signal, and
the first pixel circuits receive the first emission control signal and the first scan signal of the second division scan circuit to control emission of light by the light emitting device included in each of the first pixel circuits.

20. The display panel of claim 19, further comprising:
a second scan circuit electrically connected to a second gate line differing from the first gate line, wherein the second scan circuit receives a second emission control signal having a phase differing from a phase of the first emission control signal to generate a second scan signal having a phase differing from a phase of the first scan signal and output the second scan signal to the second gate line; and
second pixel circuits electrically connected to the second gate line, wherein the second pixel circuits receive the second scan signal and the second emission control signal to control emission of light by a light emitting device included in each of the second pixel circuits.
